(19) United States
(12) Patent Application Publication
(10) Pub. No.: US 2023/0168166 A1
(43) Pub. Date: Jun. 1, 2023

(54) ODOR SENSOR AND MANUFACTURING METHOD OF THE SAME

(71) Applicant: TAIYO YUDEN CO., LTD., Tokyo (JP)

(72) Inventors: Tomoaki KANETO, Tokyo (JP); Masashi HATTORI, Tokyo (JP)

(73) Assignee: TAIYO YUDEN CO., LTD., Tokyo (JP)

(21) Appl. No.: 18/102,570

(22) Filed: Jan. 27, 2023

Related U.S. Application Data
(63) Continuation of application No. PCT/JP2021/027702, filed on Jul. 27, 2021.

(30) Foreign Application Priority Data
Jul. 31, 2020 (JP) 2020-130999

(51) Int. Cl. G01N 5/02; B01J 20/22; B01J 20/26; B01J 20/28; B01J 20/32

(52) U.S. Cl. CPC G01N 5/02; B01J 20/226; B01J 20/262; B01J 20/3223; B01J 20/3265; B01J 20/28026

(57) ABSTRACT

An odor sensor includes a base material, and a plurality of MOF particles arranged on the base material. In an XRD measurement for the plurality of MOF particles arranged on the base material, in a range of 2θ = 5 ° to 20 °, a peak intensity of a third highest peak is ⅒ or less with respect to a peak intensity of a first highest peak.

### CROSS-REFERENCE TO RELATED APPLICATION

This application is a continuation application of International Application No. PCT/JP2021/027702, filed Jul. 27, 2021, which claims the benefit of Japanese Application No. 2020-130999, filed Jul. 31, 2020, in the Japanese Patent Office. All disclosures of the documents named above are incorporated herein by reference.

### FIELD

A certain aspect of the present invention relates to an odor sensor and a manufacturing method of the odor sensor.

### BACK GROUND

A gas detection technology using a gas adsorption film is known (see Japanese Patent Application Publication No. 2012-220454 and International Publication No. 2016/074659, for example). The gas adsorption film adsorbs specific types of gas molecules. Therefore, the target gas can be detected by detecting the presence or absence of adsorption or the amount of adsorption on the gas adsorption film. The gas adsorption film covers a wide range of fields, including gas adsorption films, self-assembled films and polymers, inorganic materials, inorganic-organic hybrid materials, and metal organic frameworks (MOFs) that enable highly sensitive and selective detection of gas molecules.

### SUMMARY OF THE INVENTION

According to an aspect of the present invention, there is provided an odor sensor including: a base material; and a plurality of MOF particles arranged on the base material, wherein, in an XRD measurement for the plurality of MOF particles arranged on the base material, in a range of 2θ = 5 ° to 20 °, a peak intensity of a third highest peak is ⅒ or less with respect to a peak intensity of a first highest peak.

According to an aspect of the present invention, there is provided an odor sensor including: a piezoelectric element having a face; a resin provided on the face of the piezoelectric element; and a plurality of MOF particles that have a flat face and are adhered onto the face of the piezoelectric element via the resin, wherein, in the plurality of MOF particles, the flat face is oriented substantially parallel to the face of the piezoelectric element.

According to an aspect of the present invention, there is provided a method of manufacturing an odor sensor, including: preparing a piezoelectric element; and fixing a plurality of MOF particles having a flat face to the piezoelectric element with a resin so that the flat face is aligned in a direction opposite to the piezoelectric element.

### BRIEF DESCRIPTION OF THE DRAWINGS

FIG. 1 is a front view illustrating an odor sensor equipped with a gas adsorption film;

FIG. 2 is a side view illustrating an odor sensor;

FIG. 3 is a diagram illustrating MOF particles included in a gas adsorption film;

FIG. 4A is a schematic perspective view illustrating a structure in which multiple MOF particles are randomly oriented on a substrate;

FIG. 4B is a side view illustrating stacking of multiple MOF particles;

FIG. 5A is a schematic perspective view illustrating a structure when multiple MOF particles are oriented on a substrate;

FIG. 5B is a stack of multiple MOF particles in a case of FIG. 5A;

FIG. 6A and FIG. 6B are side views illustrating stacking of a plurality of MOF particles;

FIG. 7 is a SEM photograph of resin (cellulose);

FIG. 8 is a SEM photograph of a resin (imide type);

FIG. 9 is a diagram illustrating XRD measurement results for MOF particles arranged on a substrate;

FIG. 10 is a process diagram illustrating a method for manufacturing a gas adsorption film;

FIG. 11A and FIG. 11B are diagrams illustrating cellulose;

FIG. 11C is a diagram illustrating an imide resin;

FIG. 12A is a plan view illustrating a resonator according to a second embodiment;

FIG. 12B is a cross-sectional view taken along line AA of FIG. 12A; and

FIG. 13 is diagram showing results of gas evaluation.

### DETAILED DESCRIPTION

High-sensitivity gas detection is desired for such a gas adsorption film, and the discovery and demonstration of an optimal material that satisfies this need is awaited.

A description will be given of an embodiment with reference to the accompanying drawings.

In the following embodiments, an odor sensor is constructed using a gas adsorption film containing MOF particles. The gas adsorption film is provided on at least a vibrating portion of a piezoelectric element. The gas adsorption film adsorbs gas to generate a mass change, which is converted into a frequency change of the piezoelectric element for detection. The piezoelectric element is a crystal oscillator, FBAR (Film Bulk Acoustic Resonator), or the like. Here, the crystal oscillator is a piezoelectric element in which electrodes are formed on a crystal, The FBAR has a cavity on a silicon substrate, and two electrodes are formed so as to sandwich the piezoelectric body. Therefore, the crystal oscillator and the FBAR are called a piezoelectric element.

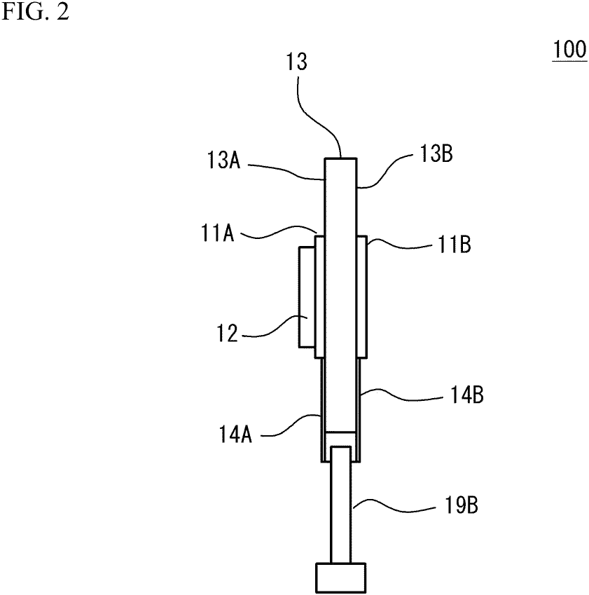

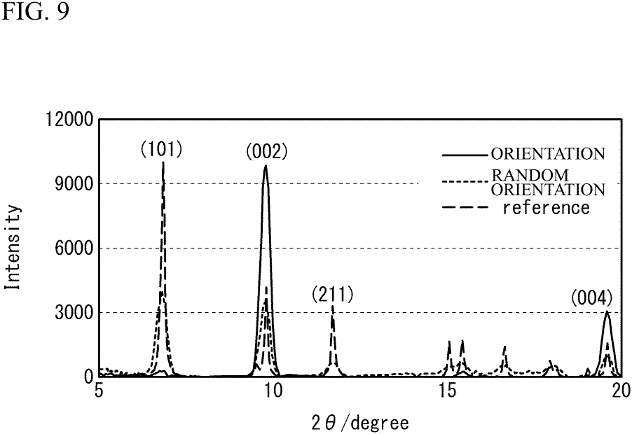

As will be described later, a resin coated on the surface of the piezoelectric element and having adhesiveness to the piezoelectric element and the MOF particles, and a plurality of MOF particles having an upper surface substantially parallel to the surface of the piezoelectric element on the resin. The piezoelectric element and the MOF particles are oriented and arranged, and a gas adsorption film is used in which the piezoelectric element and the MOF particles are fixed to each other by the resin. In the first embodiment, the gas adsorption film is provided at the vibrating portion of the piezoelectric element, and in the crystal resonator illustrated in FIG. 2, the gas adsorption film is provided on a circular gold electrode 11A. In the FBAR according to the second embodiment, the gas adsorption film is provided on the protective film 44 corresponding to the resonance region 48 illustrated in FIG. 9.

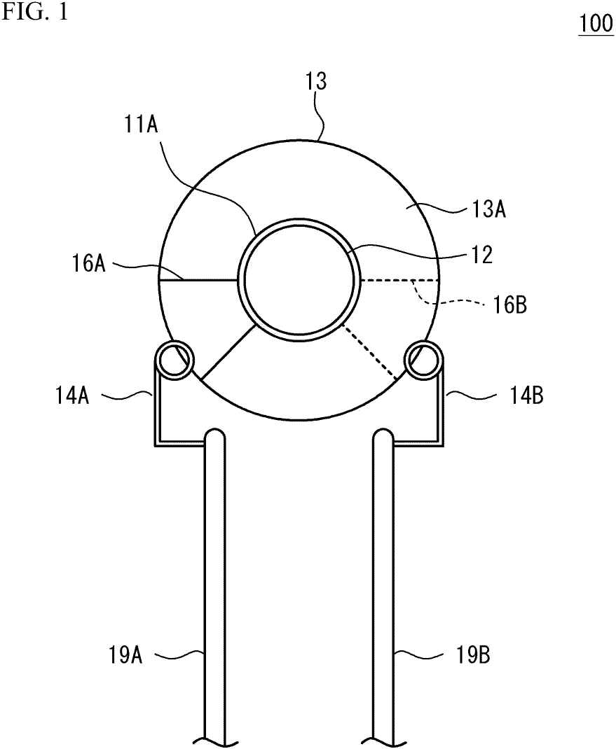

(First embodiment) FIG. 1 is a front view illustrating an odor sensor 100 equipped with a gas adsorption film. FIG. 2 is an exemplary side view of the odor sensor 100. As illustrated in FIG. 1 and FIG. 2, the odor sensor 100 includes a crystal 13, the electrodes 11A and an electrode 11B, a gas adsorption film 12 provided on at least one of the electrodes, lead lands 16A and 16B, leads 14A and 14B and pin terminals 19A and 19B. In the odor sensor 100, a set of the crystal 13 and the electrode 11A is an example of a piezoelectric element.

For the crystal 13, for example, a crystal oscillator with a resonance frequency of 32 MHz can be used.

The electrodes 11A and 11B, which are formed by patterning thin metal films into circles that are one size smaller, are formed on main faces 13A and 13B facing each other of the circular crystal 13 serving as the substrate, respectively. The electrodes 11A and 11B are gold, for example. The electrodes 11A and 11B are, for example, circular and have a diameter of 5.0 mm.

The gas adsorption film 12 is formed on the electrode 11A and adsorbs a specific gas. The lead land 16A is formed together with the electrode 11A and is integrally formed with the electrode 11A. Similarly, the lead land 16B is formed integrally with the electrode 11B.

The leads 14A and 14B are made of a metal spring material and arranged parallel to each other. The lead 14A is configured such that one end is electrically connected to the electrode 11A through the lead land 16A and the other end is connected to the pin terminal 19A. One end of the lead 14B is electrically connected to the electrode 11B through the lead land 16B, and the other end is connected to the pin terminal 19B.

The pin terminals 19A and 19B are connected to a drive circuit (oscillation circuit) to which a voltage is applied at both ends, a frequency detection circuit, an arithmetic circuit for calculating concentration and identifying gas species, and the like. These circuits drive the odor sensor 100, and a drive voltage is applied to the crystal oscillator here. When a drive voltage is applied to the odor sensor 100, the crystal 13 vibrates at a unique frequency (32 MHz). When the gas adsorption film 12 adsorbs a specific gas, the mass of the gas adsorption film 12 changes and the resonant frequency of the crystal 13 decreases according to the adsorption amount. By detecting the resonance frequency with a detection circuit or the like, the adsorption amount of a specific gas can be calculated. The concentration of the gas in the atmosphere can be calculated from the calculated adsorption amount of the gas.

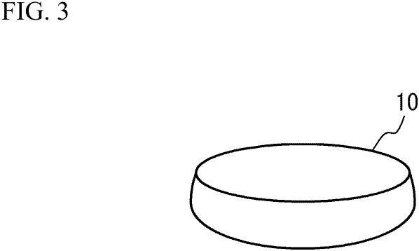

FIG. 3 is a diagram illustrating a MOF particle 10 included in the gas adsorption film 12. Note that MOF is generally called a metal organic framework, and is written as Metal Organic Frameworks in English. Therefore, the structure of the MOF is called skeleton or framework. The MOF particle 10 is a particle of a metal organic structure, and has a plurality of gas-adsorbing pores in its skeleton. The mass of the MOF particle 10 changes due to the adsorption of specific gas in the pores within the MOF particle 10. The MOF particle 10 is not particularly limited as long as it is a metal organic structure.

The MOF particle 10 will be further explained. The MOF particle 10 is a metal-organic structure, which is a highly periodic crystalline compound having a structure in which metal atoms are crosslinked with each other at organic sites. It was difficult to precisely control the pore structure and a specific surface area with the conventionally used activated carbon and zeolite. However, the characteristic of the metal organic structure is more excellent than that of the conventional porous material. In addition, the metal organic structure is a porous structure in which the pore structure, specific surface area, morphology, etc. can be artificially designed by precisely incorporating coordination bonds into the molecular design.

The shape of the MOF particle 10 employed in the experiment has a substantially disk shape or a disk shape whose upper and lower surfaces are substantially elliptical. In particular, as illustrated in FIG. 3, the two main faces (upper surface and lower surface) are larger in area than the side faces, and a plurality of openings of the holes are arranged on the upper face or the lower face. The holes extend from the openings toward inside. That is, the holes extend from the upper face to the lower face. It is a structure in which a number of holes are lined up from the top face to the bottom face. These two main faces are flat faces.

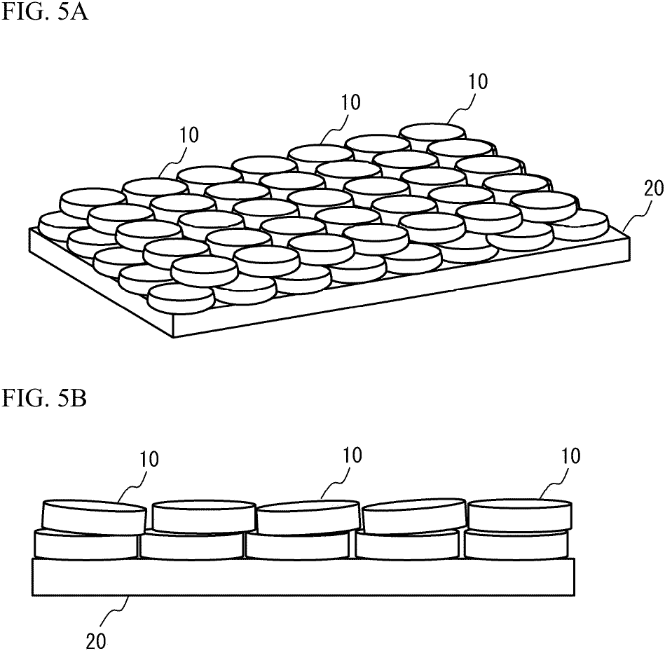

Therefore, as illustrated in FIG. 5A and FIG. 5B, by providing the upper face or the lower face with a large area parallel to the mounting face of the substrate, that is, by orienting the MOF particles, the opening of the holes on the upper face can open upward from the mounting face. In addition, the particles have a larger top face area than the side face area, and more holes on the top face than on the side faces. In other words, the number of openings of the holes that serve as gas entrances is greater than the number of openings on the side faces. As illustrated in FIG. 5A and FIG. 5B, by arranging the MOF particles evenly, the gas adsorption characteristics are remarkably improved.

The MOF particle 10 is a structure in which a metal atom (which may be a metal ion) and an organic ligand having two or more coordinating functional groups are continuously bonded. The MOF particles 10 may include some functional molecules in their pores.

The metal atoms forming the MOF particle 10 include at least one of zinc, cobalt, niobium, zirconium, cadmium, copper, nickel, chromium, vanadium, titanium, molybdenum, and aluminum. However, the metal atoms forming the MOF particle 10 are not limited to these metal elements. The metal atoms forming the MOF particle 10 may be of one type or two or more types.

As the metal raw material for the MOF particle 10, complexes containing metal ions such as Zn²⁺, Cu²⁺, Ni²⁺, Co²⁺ and metal-containing secondary structural units (SBU) are particularly suitable. The coordinating functional group of the organic ligand is a functional group capable of coordinating to a metal atom, such as carboxyl group, imidazole group, hydroxyl group, sulfonic acid group, pyridine group, tertiary amine group, amide group, thioamide group, etc. is mentioned. As the organic ligand, for example, a skeleton having a rigid structure (for example, an aromatic ring, an unsaturated bond or the like) substituted with two or more coordinating functional groups is used.

Organic ligands are, for example, 1,3,5-tris(4-carboxyphenyl) benzene (BTB), 1,4-benzenedicarboxylic acid (BDC), 2,5-dihydroxy-1,4-benzenedicarboxylic acid (DOBDC), cyclobutyl-1,4-benzenedicarboxylic acid (CB BDC), 2-amino-1,4-benzenedicarboxylic acid (H₂N BDC), tetrahydropyrene-2,7-dicarboxylic acid (HPDC), terphenyl dicarboxylic acid (TPDC), 2,6-naphthalenedicarboxylic acid (2,6-NDC), pyrene-2,7-dicarboxylic acid (PDC), biphenyldicarboxylic acid (BPDC), any dicarboxylic acid having a phenyl compound, 3, 3′,5,5′-biphenyltetracarboxylic acid, imidazole, benzimidazole, 2-nitroimidazole, cyclobenzimidazole, imidazole-2-carboxaldehyde, 4-cyanoimidazole, 6-methylbenzimidazole, 6-bromobenzimidazole and so on.

The MOF particles 10 are, for example, MOF-177 represented by Zn₄O (1,3,5-benzenetribenzoate)₂: MOF-5 represented by Zn₄O (1,4-benzenedicarboxylate)₃, also known as IRMOF-I: MOF-74 (Mg) represented by g₂(2,5-dihydroxy-1,4-benzenedicarboxylate): MOF-74 (Zn) represented by Zn₂(2,5-dihydroxy-1,4-benzenedicarboxylate): MOF-505 represented by Cu₂(3,3′,5,5′-biphenyltetracarboxylate): IRMOF-6 represented by Zn₄O(cyclobutyl-1,4-benzenedicarboxylate): IRMOF-3 represented by Zn₄O(2-amino-1,4-benzenedicarboxylate)₃: IRMOF-11 represented by Zn₄O(terphenyldicarboxylate)₃ or Zn₄O(tetrahydropyrene-2,7 -dicarboxylate)₃: IRMOF-8 represented by Zn₄O(tetrahydropyrene-2,7-dicarboxylate)₃: ZIF-68 represented by Zn(benzimidazolate)(2-nitroimidazolate): ZIF-69 represented by Zn(cyclobenzimidazolate)(2-nitroimidazolate): ZIF-7 represented by Zn(benzimidazolate)₂: ZIF-9 represented by Co(benzimidazolate)₂: ZIF-11 represented by Zn₂(benzimidazolate): ZIF-90 represented by Zn(imidazolate-2-carboxaldehyde)₂: ZIF-82 represented by Zn(4-cyanoimidazolate)(2-nitroimidazolate): ZIF-70 represented by Zn(imidazolate)(2-nitroimidazolate): ZIF-79 represented by Zn(6-methylbenzimidazolate)(2-nitroimidazolate): ZIF-81 represented by Zn(6-bromobenzimidazolate)(2-nitroimidazolate): MIL-125 represented by Ti₈O₈(OH)₄(benzene-1,4-dicarboxylate)₆.

The MOF particle 10 has, for example, a crystal structure. Since the MOF particle 10 has a regular structure, they are easily crystallized and easily obtained as single crystals or poly-crystals. The crystals may be single crystals or poly-crystals.

The median size of the crystal structure is preferably 10 nm to 500 µm, more preferably 50 nm to 10 µm, and even more preferably 100 nm to 1 µm. When the median size of the crystal structure is within the above range, both the function of the MOF particle 10 and the physical and mechanical properties of the composite can be achieved.

When the median size of the crystal structure is less than 10 nm, the number of structural units of the MOF particles 10 constituting the crystal structure is considered to be approximately 3 or less. In this case, the surface area ratio is too large when compounded in the resin. And, vacancies may not be necessarily exploited. On the other hand, when the median size of the crystal structure is more than 500 µm, the interface between the resin and the MOF particles 10 separates, reflecting the difference in physical properties (for example, elastic modulus and thermal expansion coefficient) from the resin. As a result, the interface may become a defect site of the composite material. Therefore, when the size of the crystal structure of the MOF particles 10 in the resin is too small, the functions of the MOF particles 10 will be restricted. When the size of the crystal structure of the MOF particles 10 in the resin is too large, the strength and durability of the composite material may be insufficient.

The median size of the crystal structure of the MOF particles 10 is measured by the following method. An image of the compact surface (composite material surface) is obtained using a scanning electron microscope or an optical microscope. The magnification at this time is such that the number of crystals (MOF particles 10) present in the image is 100 to 200. The maximum diameters of all crystals present in the obtained image are measured. The median value (the average value of the minimum value and the maximum value) is calculated, and the value is used as the median size of the crystal structure of the MOF particles 10.

As described above, the MOF particles 10 have a substantially plate shape. For example, as exemplified in FIG. 3, the MOF particles 10 have a substantially disk shape or a substantially elliptical disk shape. The MOF particles 10 have pore openings arranged parallel to each other with respect to two main faces (upper face and lower face). Therefore, the MOF particles 10 have good sensitivity when one of the main faces is exposed to the atmosphere. The maximum diameter of the main face of the MOF particle 10 is about 6 Å to 12 Å.

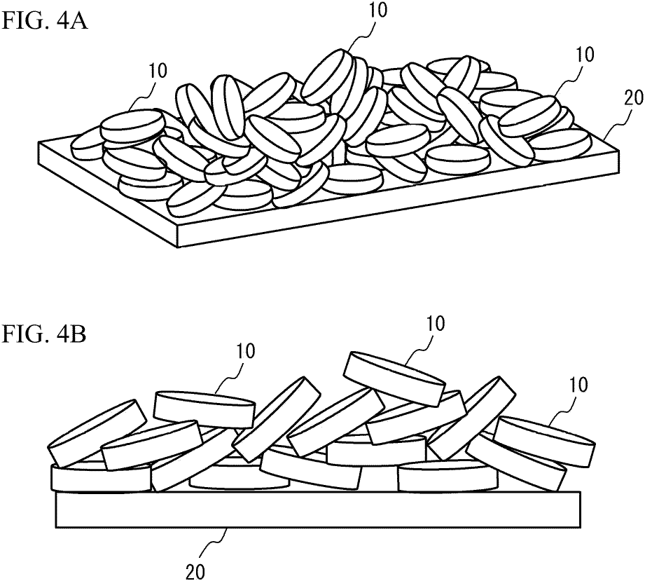

FIG. 4A is a schematic perspective view illustrating the structure when a plurality of MOF particles 10 are randomly oriented on the base material 20. FIG. 4B is a side view illustrating stacking of the plurality of MOF particles 10, and is a side view of FIG. 4A. As illustrated in FIG. 4A and FIG. 4B, when the MOF particles 10 are randomly oriented and stacked, the orientation of the MOF particles 10 becomes random. In this case, the overlap between the MOF particles 10 increases. And, in many cases, the substantially circular main face of the MOF particle 10 is covered with other MOF particles 10. Therefore, the amount of gas adsorbed on the MOF particles 10 is reduced.

In general, when MOF particles are provided by themselves, they have poor adhesiveness to a substrate (or base material). Even if the MOF particles are applied to a substrate (or base material, an electrode thereon, or a ceramic-based passivation film (here, a silicon oxide film, a silicon nitride film, a glass film or the like), the MOF particles may be peeled and removed. Here, the substrate is a portion on which the gas adsorption film is provided, and is the crystal portion of the crystal oscillator. Also, the base material refers to the material on which the gas adsorption film is provided, which is a gold electrode here.

Because of this peeling characteristic, the present inventors have thought that the MOF particles are mixed with resin and applied in order to achieve an adhesive effect. The results are the following two experiments. In other words, this resin has adhesiveness with the above-described piezoelectric element and has adhesiveness between MOF particles. Therefore, the MOF particles are adhered and fixed to the piezoelectric element through the resin.

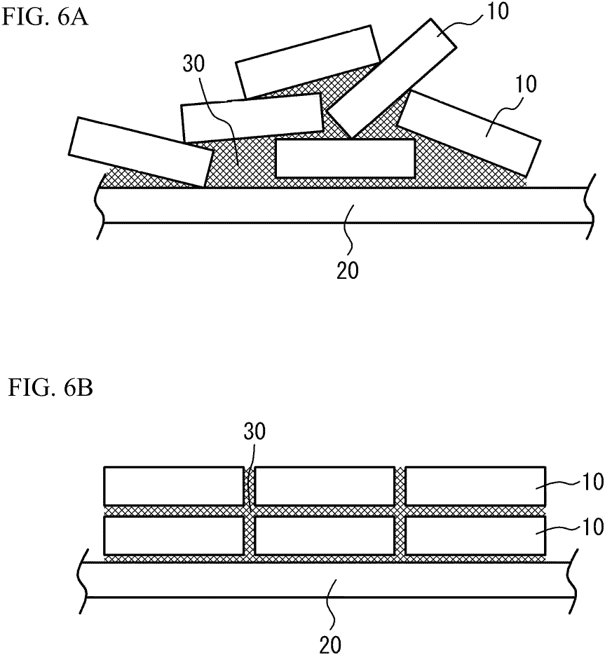

In the first experiment, cellulose was used as the resin and acetone was used as the solvent. FIG. 4A and FIG. 4B illustrate MOF particles in the cellulose dissolved in the acetone, applied by spraying and dried. As illustrated in FIG. 4A and FIG. 4B, four or more layers of MOF particles 10 were stacked in the Z-axis direction without the same orientation. Like the top and bottom of a mountain, there were thin and thick layers. In the thick layer, beanbag-like discs piled up randomly in the horizontal, diagonal, and vertical directions to form a mountain. This was the same result on the crystal and on the gold electrode. Also, as illustrated in FIG. 6A, the resin 30 adheres the MOF particles 10 in various orientations.

On the other hand, in the second experiment, polyimide was used as the resin and acetone was used as the solvent. FIG. 5A and FIG. 5B illustrate MOF particles in the polyimide dissolved in the acetone, applied by spraying and dried.

In FIG. 5A and FIG. 5B, the disk shapes were aligned, that is, the top face of the disk was aligned parallel to the face of the substrate or base material, and the holes extending from the top face to the bottom face of the disk were aligned almost perpendicularly with respect to the substrate or base material. It has been found that in this structure, many openings of the holes were arranged on the upper face of the disk, improving the easiness of gas inflow and outflow, and improving the adsorption property. Further, as illustrated in FIG. 6B, a thin layer of the resin 30 was formed between the MOF particles 10 to bond the MOF particles 10 together.

Although the cause of the difference between the first and second experiments was not clear, we considered it below.

According to a first analogy, since the MOF particles are disk-shaped, it is thought that if they are applied to the surface of a horizontal substrate or base material, they will be aligned to some extent as illustrated in FIG. 5A and FIG. 5B. However, as illustrated in FIG. 4A and FIG. 4B, when cellulose is used, there are thin portions and thick portions. And the fact that the discs are randomly stacked, especially in the thicker part, may be due to the non-flatness or characteristic of the molten resin. It is inferred that the main cause is that the cellulose itself has thin and thick parts and is stuck there and dried.

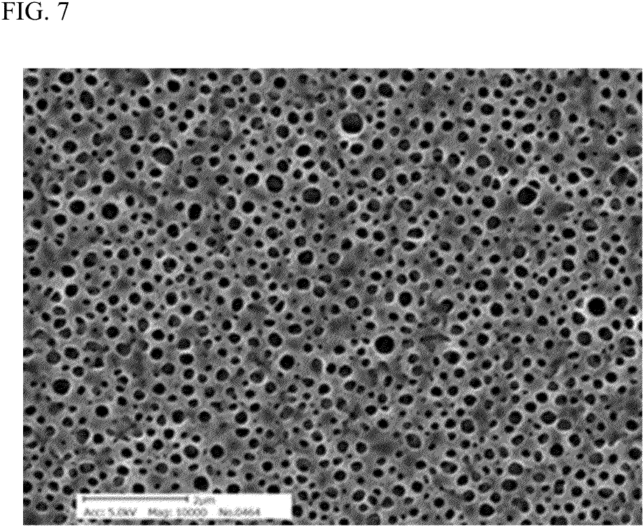

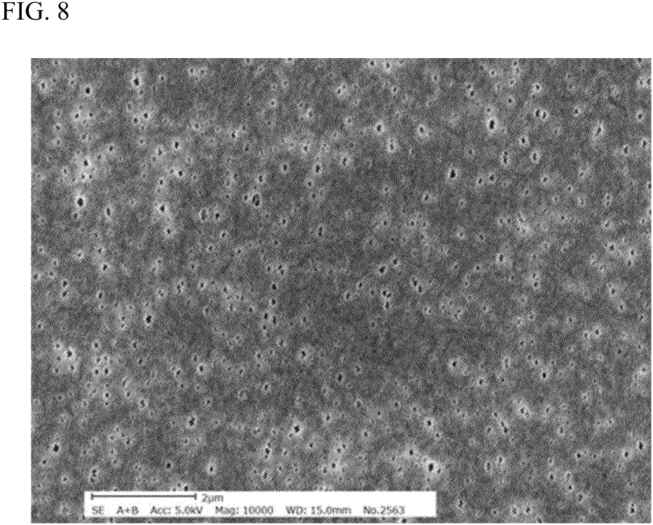

On the other hand, in the second experiment, it is inferred that a thin and uniform film of polyimide existed on the surface of the base material and was arranged on top of the polyimide. When the surface states of both materials are compared by SEM (see FIG. 7, which is an SEM photograph of the first experiment, and FIG. 8, which is an SEM photograph of the second experiment), both have pores on the membrane surface, and the pore diameter of the cellulose is larger than that of the polyimide.

Therefore, it is inferred that the MOF particles are likely to be arranged vertically or obliquely by entering the pores of the cellulose surface (entering in the form of sticking), and the orientation state becomes random.

In particular, the pores of cellulose are not perfectly circular, but rather large pores with diameters of 500 nm to 600 nm are scattered about. In addition, the MOF particles have a flat circular diameter of 1000 nm to 1500 nm and a thickness direction of about 400 nm. It is conceivable that the tip of the disk might get stuck in a large hole in the cellulose. In the case of a disk with an elliptical plane, there is a greater tendency for the tip to pierce. In this case, the sizes of the long axis and the short axis are distributed from 1000 nm to 1500 nm and from 800 nm to 1200 nm, respectively.

On the other hand, since the polyimide film itself is dense, the long part (long side) of the hole is about 100 nm, and it seems that there is no room for penetration. In other words, in order to achieve the orientation, it is necessary that the holes formed by the resin that has adhesiveness to the piezoelectric element, the substrate, or the base material and has adhesiveness to the MOF particles is about 10% or less of the MOF particles.

When actually applying, the binder resin and MOF are sprayed together. Even if the particles were aligned upward when they landed, it is considered that holes are formed when acetone volatilizes from the binder resin. Since the pores of cellulose are sufficiently large, it is thought that the MOF particles are tilted as if they are dragged by the generated pores. In the case of polyimide with small pores, it is thought that almost no tilting occurs or only a slight tilting occurs.

Thus, in this embodiment, each MOF particle 10 is arranged on the base material 20 with an orientation. FIG. 5A is a schematic perspective view illustrating a structure in which two to three layers of MOF particles 10 are vertically stacked on a base material 20 and oriented so that the upper surface faces upward. FIG. 5B is a schematic side view of FIG. 5A and is a side view illustrating stacking of a plurality of MOF particles 10. Here, two MOF particles overlap. In order to improve the adhesion between the MOF particles 10 and the base material 20, a resin 30 made of polyimide is provided between the MOF particles 10 and the base material 20 as a binder. The base material 20 provided with the MOF particles 10 corresponds to the gas adsorption film 12. Of the two flat main surfaces of the plurality of MOF particles 10, the main surface opposite to the crystal 13 is aligned so as to be substantially parallel to the surface of the electrode 11A.

As illustrated in FIG. 5A and FIG. 5B, when the MOF particles 10 are oriented and stacked, the overlap between the uppermost MOF particles 10 is reduced so that a substantially circular or substantially elliptical main surface becomes more likely to be exposed to the atmosphere. Therefore, the amount of gas adsorbed on the MOF particles 10 increases, making it possible to detect the gas with high sensitivity.

FIG. 9 is a diagram illustrating XRD (X-ray diffraction) measurement results for the MOF particles 10 arranged on the base material 20 in this embodiment. FIG. 9 illustrates the XRD measurement results for the MOF particles 10 randomly arranged on the base material 20, the XRD measurement results for the MOF particles 10 oriented and arranged on the base material 20, and the XRD measurement results for reference MOF particles. The reference MOF particles are MOFs made of the same material as the MOF particles 10 and in the form of powder.

As illustrated in FIG. 9, the reference MOF particles have peaks in many orientations. Also, each peak has a relatively high peak intensity. This is because the reference MOF particles are powdery and oriented in various directions. Even when the MOF particles 10 are randomly oriented, peaks appear in many directions, although the peaks are not clear with respect to the reference. This is because each MOF grain 10 is oriented in different directions.

On the other hand, when the MOF particles 10 are oriented in a predetermined direction, peaks appear clearly on a plurality of specific planes. As a result, the number of peaks is smaller than when the MOF particles 10 are randomly oriented. In FIG. 9, a first peak with the highest peak intensity appears for the (002) plane, a second peak with the second highest peak intensity appears for the (004) plane, and a third peak with the third highest peak intensity appears the (101) plane. When the MOF particles 10 are oriented in a predetermined direction, the peak intensity of the first peak is relatively larger than the peak intensities of the other peaks. In this embodiment, the peak intensity of the third peak is ⅒ or less times the peak intensity of the first peak in the range of 2θ=5° to 20°.

When the peak intensity of the third peak is ⅒ or less of the peak intensity of the first peak in the range of 2θ = 5° to 20°, the orientation of each MOF particle 10 becomes high and the amount of gas adsorbed by the MOF particles 10 increases. In the range of 2θ = 5° to 20°, it is sufficient that the peak intensity of the third peak is ⅒ or less of the peak intensity of the first peak. Therefore, the direction of each MOF particle 10 may not necessarily coincide with each other. The direction of each MOF particle 10 may vary.

It should be noted that when the orientation of each MOF particle 10 increases, the peak intensity of the first peak relatively increases and the peak intensity of the third peak relatively decreases. Therefore, by increasing the orientation of each MOF particle 10, the peak intensity of the third peak becomes 1/15 times or less as the peak intensity of the first peak in the range of 2θ = 5° to 20° or 1/20 times or less as the peak intensity of the first peak in the range of 2θ = 5° to 20°.

In addition, when the orientation increases, the number of peaks having a peak intensity of 1/20 or more times as the peak intensity of the first peak decreases. For example, in the range of 2θ=5° to 20°, there are 4 or less peaks whose peak intensity is 1/20 or more times as the peak intensity of the first peak. This is because, for example, crystal planes such as the (002) plane are arranged at regular intervals, and in the range of 2θ = 5 ° to 20 °, four peaks (5 °, 10 °, 15 °, 20 °) appear at most.

In order to obtain a sufficient peak intensity in the XRD measurement, for example, the sample size is 1 cm square and the film thickness is 1 µm or more. Also, the diameter of the portion irradiated with X-rays is 5 mm × 5 mm.

The MOF particles 10 may be stacked. And as illustrated in FIG. 5A, when the orientation is high, two or more of the MOF particles 10 are significantly stacked so as to overlap each other in a plan view with respect to the surface of the crystal 13. When the average number of layers of the MOF particles 10 on the base material 20 is small, there may be areas where the MOF particles are not deposited on the electrodes of the crystal oscillator, and the sensitivity may be attenuated accordingly. Therefore, it is preferable to set a lower limit to the average number of stacked layers of the MOF particles 10. For example, the average number of laminated layers of the MOF particles 10 is preferably two or more.

When the average number of stacked layers of the MOF particles 10 on the base material 20 is large, there is a risk that the oscillation characteristics of the crystal oscillator may deteriorate. Therefore, it is preferable to set an upper limit for the average number of stacked layers of the MOF particles 10. For example, the average number of stacked MOF particles 10 is preferably 3 or less.

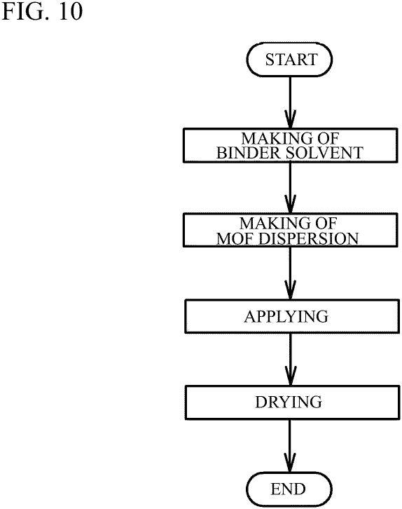

(Manufacturing method of odor sensor) Next, a method for manufacturing the odor sensor 100 will be described. FIG. 10 is a process diagrams illustrating a method for manufacturing the odor sensor 100.

(Binder solution preparation process) A binder solution is prepared by dissolving the binder in a solvent. The solvent is not particularly limited as long as it can dissolve the binder. Acetone, THF (tetrahydrofuran), cyclohexanone, or the like can be used as a solvent. When the binder concentration is too high, the MOF particles are excessively coated with the binder, so the binder concentration in the binder solution may be 0.1 wt % to 1.0 wt %.

(MOF dispersion preparation process) Next, MOFs for forming the MOF particles 10 are added and dispersed in the binder solution. Thereby, a MOF dispersion is produced. For example, an MOF dispersion can be prepared by stirring using a stirring means such as a stirring blade, homogenizer, bead mill, or a rotation-revolution stirring method apparatus to disperse the MOF in the binder solution. The solid content weight ratio between the MOF and the binder is preferably 0.5:1 to 10:1, for example.

The MOF can be synthesized by a known method. When the desired MOF is commercially available, a commercial product may be used. A plurality of methods for synthesizing MOFs are known, and the method for synthesizing MOFs used in the present invention is not particularly limited. Methods for synthesizing MOF include a solution method, a hydrothermal method, and the like. In addition, solid-phase synthesis method (mechanochemical method), microwave method, ultrasonic method and the like can be used.

The solution method is a method of mixing a solution of metals (metal complexes or metal-containing secondary structures) and a solution of organic ligands in the presence of a catalyst, if necessary. At this time, when the solvent for the metals solution and the solvent for the organic ligand solution are difficult to mix, the MOF synthesis reaction occurs at the interface. At this time, when the reaction system is allowed to stand still, relatively large MOF crystals may grow at the interface. When the solvent for the metals solution and the solvent for the organic ligand solution are easily miscible, or when those solvents are the same solvent, the reaction will occur everywhere, resulting in fine crystals or poly-crystals.

The hydrothermal method is a method in which a solution in which metals and organic ligands are dissolved in a solvent is sealed in a pressure-resistant container and heated above the boiling point of the solvent to cause a reaction at high temperature and high pressure. It is suitably used when reacting substances with low reactivity.

When the above-mentioned materials (metals, organic ligands, etc.) are used and synthesized by these synthesis methods, various MOFs are synthesized depending on the materials. MOFs can be synthesized with a high degree of freedom in design by selecting and combining metals and organic ligands, or by using a plurality of metals and organic ligands in combination.

(Coating process) Next, the MOF dispersion is set in a spray device or the like, and the MOF dispersion is applied to one face of the base material 20. The method of applying the MOF dispersion to the base material 20 is not particularly limited, and for example, a roll coater, bar coater, letterpress printing, intaglio printing, etc. can be used for application to a flat surface or film. However, it is preferable to use a spray device because spin coating may result in application to areas other than the intended application area, and crystal may crack with a roll coater or bar coater.

(Drying process) After that, the solvent is volatilized from the MOF dispersion. A method for volatilizing the solvent is not particularly limited. A known drying method such as drying by heat, drying by reduced pressure, or air drying may be used. Through the steps described above, the gas adsorption film 12 can be produced. By fixing the gas adsorption film 12 to the gold electrode 11A on the crystal 13, the main structure of the odor sensor 100 is obtained.

In the manufacturing method according to the present embodiment, by using a resin having a bulky functional group such as a trifluoromethyl group or a hexafluoroisopropyl group as a binder, the distance between molecules increases, the interaction between separations weakens, and the aggregation of resin can be suppressed. By suppressing aggregation of the resin, the orientation of each MOF particle 10 can be increased.

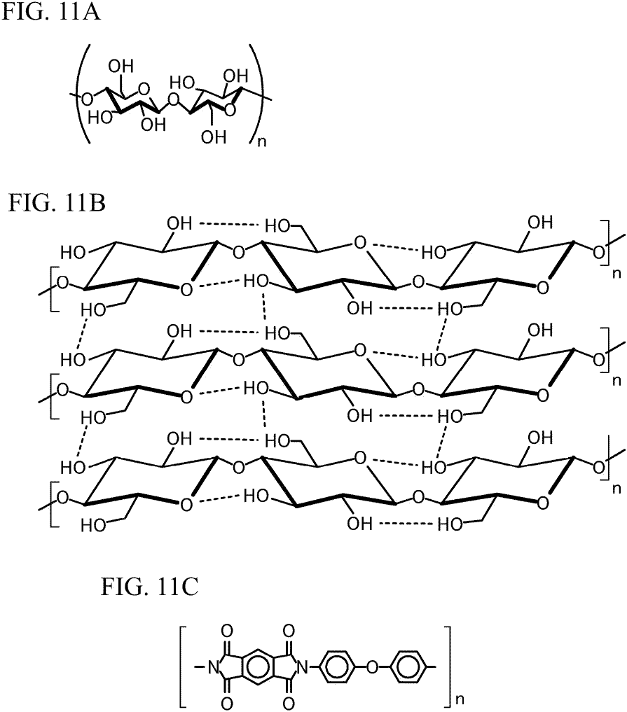

FIG. 11A is a diagram illustrating the structure of cellulose. Cellulose contains a large amount of hydroxyl groups. Cellulose molecules have a tendency to aggregate through hydrogen bonding (intermolecular interaction). When cellulose is used as the binder, the bonding strength between the OH groups becomes stronger as illustrated in FIG. 11B. Therefore, when cellulose is used as the binder, each MOF particle 10 tends to be randomly oriented. As mentioned above, this seems to be related to the random arrangement due to the pore size of the cellulose membrane.

In addition to the bulky functional groups described above, aggregation of the resin can be suppressed by introducing an alicyclic structure, introducing a meta bond or an ether bond, or introducing a fluorine atom into the resin. For example, the resin used for the binder is preferably an imide-based resin illustrated in FIG. 11C. This is because polyimide has structural diversity due to its molecular design, so that it is easy to introduce target functional groups, and it is easier to control intermolecular interactions than other resins. In addition to imide-based resins, fluorine-based resins, acrylic-based resins, ester-based resins, and the like can be used. As noted above, any fine resin having a diameter or major axis that is approximately 10% or less of the diameter or major axis of the MOF particles is considered oriented.

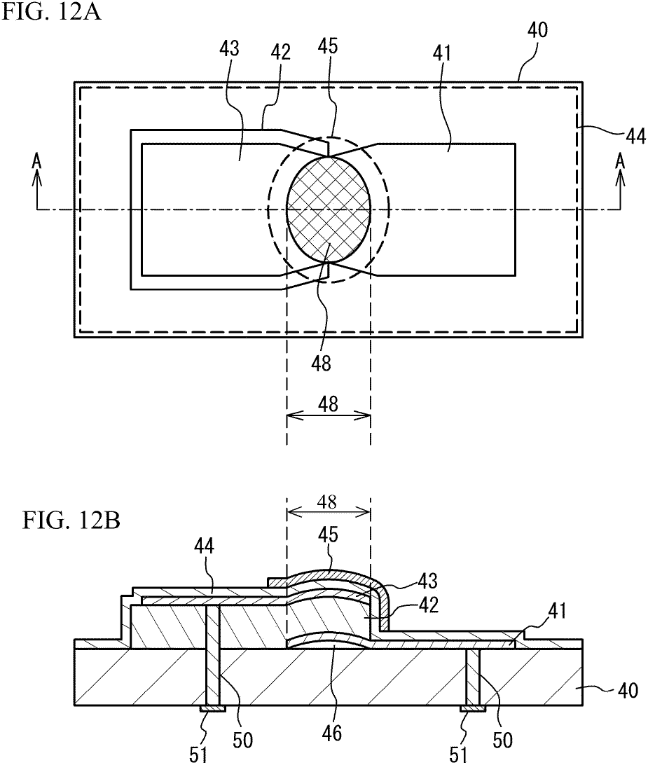

(Second embodiment) A piezoelectric thin film resonator equipped with a gas adsorption film will be explained. FIG. 12A is a plan view illustrating the resonator according to a second embodiment. FIG. 12B is a cross-sectional view taken along a line AA of FIG. 12A.

As illustrated in FIG. 12A and FIG. 12B, a piezoelectric film (also referred to as a vibrating portion) 42 is provided on a substrate 40. A lower electrode 41 and an upper electrode 43 are provided so as to sandwich the piezoelectric film 42. An air gap 46 is formed between the lower electrode 41 and the substrate 40. A resonance region 48 is a region where the lower electrode 41 and the upper electrode 43 face each other with at least a part of the piezoelectric film 42 interposed therebetween. In the resonance region 48 , the lower electrode 41 and the upper electrode 43 excite an elastic wave in the thickness longitudinal vibration mode within the piezoelectric film 42. A protective film 44 is provided on the substrate 40 so as to cover the lower electrode 41 , the piezoelectric film 42 and the upper electrode 43. Here, an insulating inorganic protective film 44 such as a silicon oxide film, a silicon nitride film, or a glass film used in semiconductor manufacturing is employed, and a gas adsorption film 45 is provided on this protective film. In plan view, the gas adsorption film 45 is covered including the resonance region 48. An electrode 51 is provided on the bottom surface of the substrate 40. A through electrode 50 is provided to penetrate the substrate 40 and the piezoelectric film 42. The through electrode 50 connects the lower electrode 41 and the upper electrode 43 to the electrode 51. FIG. 12A and FIG. 12B show a surface mount type which is connected by soldering on the back surface of the substrate. However, in the wire bond type, there is no through electrode. In this embodiment, the piezoelectric film 42, the upper electrode 43 and the protective film 44 are examples of piezoelectric elements.

When gas molecules are adsorbed on the gas adsorption film 45, the mass of the gas adsorption film 45 increases. As the mass of the gas adsorption film 45 in the resonance region 48 increases, the resonance frequency and anti-resonance frequency of the piezoelectric thin film resonator decrease. As the gas adsorption film 45, the same material as the gas adsorption film 12 described in the first embodiment is used.

The substrate 40 is, for example, a sapphire substrate, an alumina substrate, a spinel substrate or a silicon substrate. The lower electrode 41 and the upper electrode 43 are metal films such as ruthenium (Ru) films. The piezoelectric film 42 is, for example, an aluminum nitride (AlN) film, a zinc oxide (ZnO) film, a crystal layer, or the like. The protective film 44 is an insulating film such as a silicon oxide film or a silicon nitride film. The through electrode 50 and the electrode 51 are metal layers such as a gold (Au) layer or a copper (Cu) layer.

Instead of the air gap 46, an acoustic reflection film that reflects elastic waves propagating in the vertical direction through the piezoelectric film 42 can be used. The planar shape of the resonance region 48 may be a polygon such as a quadrangle or a pentagon, in addition to the elliptical shape.

Also in this embodiment, as the gas adsorption film 45, the same material as the gas adsorption film 12 of the first embodiment is used, so the gas can be detected with high sensitivity. In this embodiment, of the two flat main faces of the plurality of MOF particles 10 , the main face opposite to the piezoelectric film 42 is aligned so as to face substantially parallel to the face of the protective film 44 .

### EXAMPLES

Below, gas adsorption films that can be used as the gas adsorption film 12 according to the first embodiment and the gas adsorption film 45 according to the second embodiment were produced, and their characteristics were investigated.

(Example) In the examples, polyimide was used as the binder. Acetone was used as the solvent. MIL-125 was used for the MOF. First, polyimide was dissolved in acetone to prepare a binder solution. MIL-125 was added to the binder solution and dispersed to prepare an MOF dispersion. After that, the MOF dispersion liquid was set in a spray device and coated on the surface of the sensor element to prepare a gas adsorption film.

(Comparative example) In the comparative example, the conditions were the same as in the example except that cellulose was used as the binder.

(XRD measurement) An XRD measurement was performed on the gas adsorption films of Examples and Comparative Examples. Table 1 shows the results. For the comparative example, many peaks were observed, and the peak intensity of each peak was relatively large. This is probably because each MOF particle 10 was randomly oriented in the comparative example. On the other hand, in the example, the number of observed peaks decreased, and the peak intensity of the third peak was less than ⅒ times or less as the peak intensity of the first peak. It is considered that this is because the MOF particles 10 were oriented in a predetermined direction in the example.

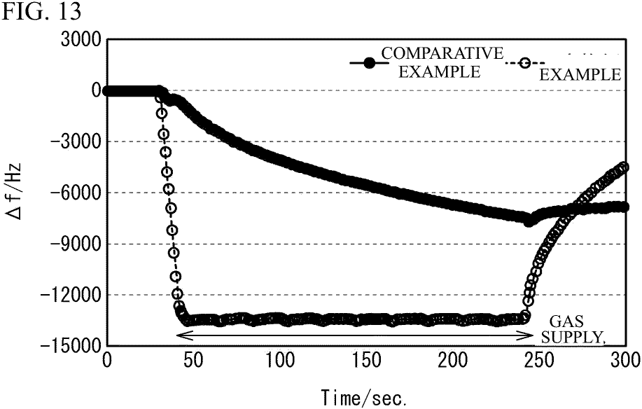

(Gas evaluation) A gas with a constant concentration was flowed from the gas generator to the gas adsorption membranes of the example and the comparative examples, and the change in mass due to adsorption was measured. FIG. 13 is a diagram showing the results of gas evaluation. The horizontal axis of FIG. 13 indicates time (seconds), and the vertical axis indicates the frequency (Hz) of the crystal oscillator. As illustrated in FIG. 13, in the example, the frequency abruptly changed over time. This is probably because each MOF particle 10 is oriented in a predetermined direction, so that the gas adsorption speed was improved and the gas adsorption amount was increased. On the other hand, in the comparative example, the frequency did not change as rapidly as in the example. This is probably because the MOF particles 10 were randomly oriented, which lowered the gas adsorption speed and reduced the gas adsorption amount. It is considered that the desorption rate of gas from the gas adsorption film increases when the MOF particles 10 are oriented in a predetermined direction.

(SEM observation) The surface state of each of the gas adsorption films of the example and the comparative example was observed at high magnification using SEM. In the example, each MOF particle 10 was arranged relatively uniformly and no agglomeration was observed. It is considered that this is because the MOF particles 10 were oriented in a predetermined direction. On the other hand, in the comparative example, portions where the MOF particles 10 aggregated were observed. It is thought that this is because the MOF particles 10 were randomly oriented.

TABLE 1

| | BINDER | ORIENTATION CONDITION | GAS ADSORPTION AMOUNT [Hz] | ADSORPTION SPEED | CONDITION OF FILM |
|---|---|---|---|---|---|
| EXAMPLE | POLYIMIDE | ORIENTATION | 13000 | FAST | EVEN |
| COMPARATIVE EXAMPLE | CELLULOSE | RANDOM | 7000 | SLOW | AGGREGATION |

Although the embodiments of the present invention have been described in detail, it is to be understood that the various change, substitutions, and alterations could be made hereto without departing from the spirit and scope of the invention. For example, the gas adsorption film may be a ceramic oscillator, a cantilever, a diaphragm, or the like, in addition to the crystal resonator of the first embodiment and the surface acoustic wave device of the second embodiment. It can also be applied to other vibrating elements that can detect physical changes such as increases and convert them into electrical signals.

What is claimed is:

1. An odor sensor comprising:
a base material; and
a plurality of MOF particles arranged on the base material,
wherein, in an XRD measurement for the plurality of MOF particles arranged on the base material, in a range of 2θ = 5 ° to 20 °, a peak intensity of a third highest peak is ⅒ or less with respect to a peak intensity of a first highest peak.

2. The odor sensor according to claim 1, wherein the plurality of MOF particles are substantially disc-shaped or substantially ellipsoid-shaped.

3. The odor sensor according to claim 1, wherein the plurality of MOF particles are MII,-125.

4. The odor sensor according to claim 1, wherein the plurality of MOF particles are adhered to the base material with an imide resin and are adhered to each other among the plurality of MOF particles.

5. An odor sensor comprising:
a piezoelectric element having a face;
a resin provided on the face of the piezoelectric element; and
a plurality of MOF particles that have a flat face and are adhered onto the face of the piezoelectric element via the resin,
wherein, in the plurality of MOF particles, the flat face is oriented substantially parallel to the face of the piezoelectric element.

6. The odor sensor according to claim 5, wherein the plurality of MOF particles are substantially disc-shaped or substantially ellipsoid-shaped.

7. The odor sensor according to claim 5, wherein a pore formed in the resin is approximately 10% or less of a diameter or major axis of the plurality of MOF particles.

8. The odor sensor according to claim 5, wherein two or more of the plurality of MOF particles overlap in plan view with respect to the face of the piezoelectric element.

9. The odor sensor according to claim 5, wherein the piezoelectric element is a crystal oscillator.

10. The odor sensor according to any claim 5, wherein the piezoelectric element is FBAR.

11. The odor sensor according to claim 5,
wherein, in an XRD measurement for the plurality of MOF particles arranged in the piezoelectric element, in a range of 2θ = 5 ° to 20 °, a peak intensity of a third highest peak is ⅒ or less with respect to a peak intensity of a first highest peak.

12. A method of manufacturing an odor sensor, comprising:
preparing a piezoelectric element; and
fixing a plurality of MOF particles having a flat face to the piezoelectric element with a resin so that the flat face is aligned in a direction opposite to the piezoelectric element.

13. The method according to claim 12, wherein the plurality of MOF particles are substantially disc-shaped or substantially ellipsoid-shaped.

14. The method according to claim 12, wherein the resin has a functional group that weakens intermolecular interaction.

15. The method according to claim 14, wherein the functional group that weakens the intermolecular interaction is a trifluoromethyl group or a hexafluoroisopropyl group.

16. The method according to claim 14, wherein the resin is an imide resin.
